(19) United States
(12) Patent Application Publication
(10) Pub. No.: US 2008/0144793 A1
(43) Pub. Date: Jun. 19, 2008

(54) SYSTEM AND METHOD FOR MANAGEMENT OF PROVISIONABLE MENUING IN AN INTELLIGENT ELECTRONIC DEVICE

(75) Inventor: Douglas Graham King, Plano, TX (US)

Correspondence Address: AKIN GUMP STRAUSS HAUER & FELD, LLP, P O BOX 688, DALLAS, TX, 75313-0688, US

(73) Assignee: UNIDEN AMERICA CORPORATION, Fort Worth, TX (US)

(21) Appl. No.: 11/612,344

(22) Filed: Dec. 18, 2006

(51) Int. Cl. H04M 3/42

(52) U.S. Cl. 379/201.02; 370/259

(57) ABSTRACT

A method and system of remotely managing phone menus in a phone system of one or more intelligent phones is disclosed. The method includes: providing a configuration server, wherein the configuration server includes custom phone menu options and default phone menu options; creating a custom phone menu that includes one or more of the custom phone menu options for at least one of the one or more intelligent phones; coupling the at least one of the one or more intelligent phones to the configuration server; and sending the custom phone menu to the at least one of the one or more intelligent phones via the configuration server.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A “MICROFICHE APPENDIX”

Not Applicable.

### BACKGROUND OF THE INVENTION

The present invention generally relates to telecommunications devices, and specifically to an intelligent multi-functional electronic device.

The telecommunications industry continues to witness rapid changes in the way people and organizations communicate. Many of these changes spring from the explosive growth of the Internet and from applications based on Internet Protocol (IP). The Internet has become an omnipresent means of communication, and the total amount of packet-based network traffic has quickly surpassed traditional voice (circuit-switched) network traffic, such as PSTN's (Public Switched Telephony Networks) and the like.

Technological advancements have helped telecommunication service providers, users, and suppliers realize that voice traffic and services may be one of the next major inroads to take full advantage of IP. This expectation is based on the impact of a new set of technologies generally referred to as Voice over IP (VoIP) or IP telephony.

Network administrators or customers who use Voice over IP (VoIP) or IP telephony face challenges in deploying IP phones to end-users. In particular, administrators and customers need to provide an IP phone with a configuration appropriate or correct for each individual user and including a variety of parameters, such as phone numbers and particular feature sets for each phone. For example, an IP phone that is deployed at a reception desk might require an entirely different feature set and configuration than a phone deployed to a conference room. Different individuals can also require different phone numbers and/or feature sets depending on the roles of the individuals in an organization.

In some conventional approaches, VoIP phones are shipped to the customer with pre-programmed menus according to the customer's anticipated needs. For example, a business customer may anticipate a need for one receptionist phone, two conference room phones, and seven general-user phones, where the menus of available functions for each of the different types of phones (i.e., receptionist, conference room, and general user) are different. The business will order ten phones, where one phone is provided with a receptionist menu, two phones with conference-room menus, and seven phones with general-user menus. If the phone needs of the business later changes, for example such that it actually needs eight general-user phones and only one conference-room phone, the options would be to order a new general-user phone (and leave the extra conference-room phone unused), give the eighth general-user a conference-room phone (which may be an inconvenience for the user), or have the extra conference-room phone re-programmed by a technician, which would require either shipping the phone to the technician or having the technician physically present at the phone to do the necessary re-programming.

What is needed is an improved system and method for management of provisionable menuing in an intelligent electronic device.

### SUMMARY OF THE INVENTION

The present invention discloses a method and system for designing a dynamic menu structure, that at the time of provisioning, an administrator can remotely manage VoIP phone menuing for each, or a group of, VoIP phone customers by sending both a default configuration file and a customized configuration file to designated IP phones.

Therefore, in accordance with the previous summary, objects, features and advantages of the present disclosure will become apparent to a person of the ordinary skill in the art from the subsequent description and the appended claims taken in conjunction with the accompanying drawings.

### BRIEF DESCRIPTION OF THE DRAWINGS

FIG. 1 is a diagram of an exemplary intelligent phone;

FIG. 2 is a diagram of the screen of the phone along with several keys;

FIG. 3 is a diagram illustrating remote management of IP phone menuing according to the present invention;

FIG. 4 is a diagram showing some example menu hierarchies; and

FIG. 5 is a diagram illustrating the functional relationships of the present invention.

### DETAILED DESCRIPTION

The present disclosure can be described by the embodiments given below. It is understood, however, that the embodiments below are not necessarily limitations to the present disclosure, but are used to describe a typical implementation of the invention.

The present invention provides a unique method and system for remote management of menuing in an intelligent electronic device. It is understood, however, that the following disclosure provides many different embodiments, or examples, for implementing different features of the invention. Specific examples of components, signals, messages, protocols, and arrangements are described below to simplify the present disclosure. These are, of course, merely examples and are not intended to limit the invention from that described in the claims. Well known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art. Details regarding control circuitry described herein are omitted, as such control circuits are within the skills of persons of ordinary skill in the relevant art.

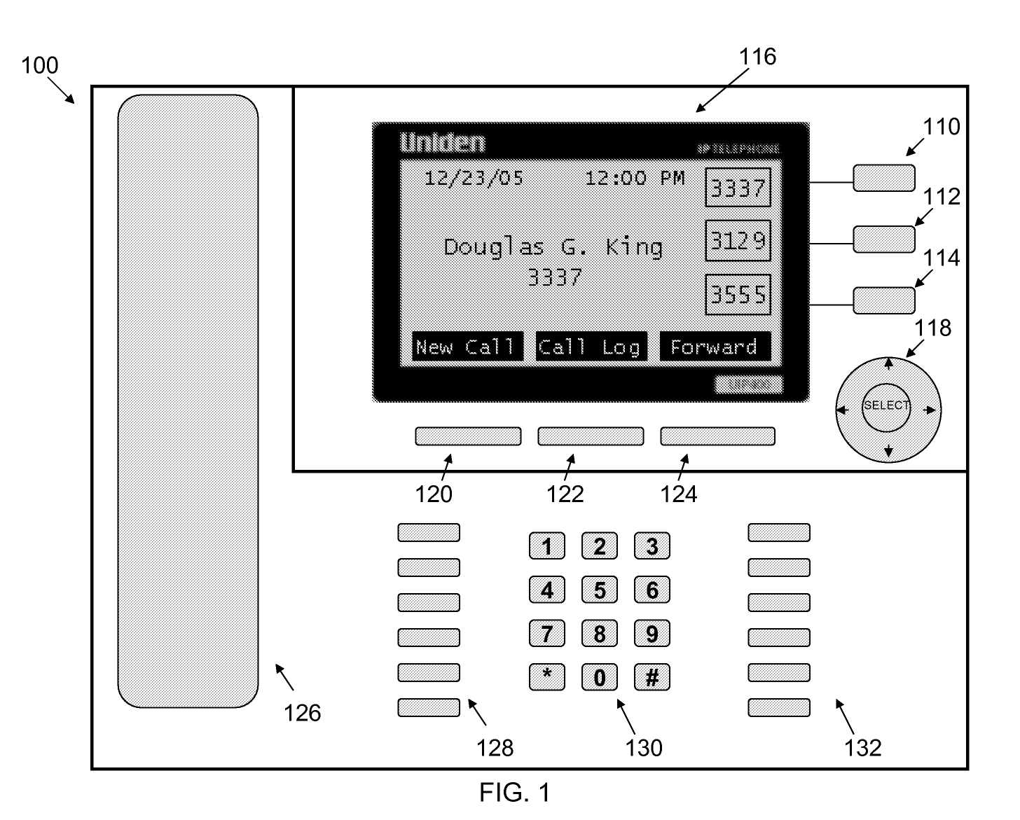

FIG. 1 illustrates an exemplary intelligent phone 100. The phone 100 is shown merely as an example and is not intended to be limiting. In alternative embodiments, the concepts presented herein can be used in connection with any type of VoIP end device, including, but not limited to, audio-equipped personal computers, single-use appliances, or any other communication device capable of voice data communications. In still further alternative embodiments, the concepts disclosed herein can be used with any device that includes a graphical menu interface.

The phone 100 utilizes VoIP technology. The phone 100 has a first line key 110 that operates a first line (extension 3337 in this example), a second line key 112 that operates a second line (extension 3129 in this example), and a third line key 114 that operates a third line (extension 3555 in this example). The phone 100 also includes a display screen 116 for displaying information about options and lines for the user. The display screen 116 can include an electronic display device such as a monochrome or full-color liquid crystal display device. The phone 100 also includes a navigation toggle key 118, which can serve a variety of purposes such as navigating icons on the screen 116. The phone 100 also includes a first function key 120, a second function key 122, and a third function key 124. The phone also includes a handset 126, which can be corded or cordless, a first set of additional feature keys 128, a traditional number pad 130, and a second set of additional feature keys 132.

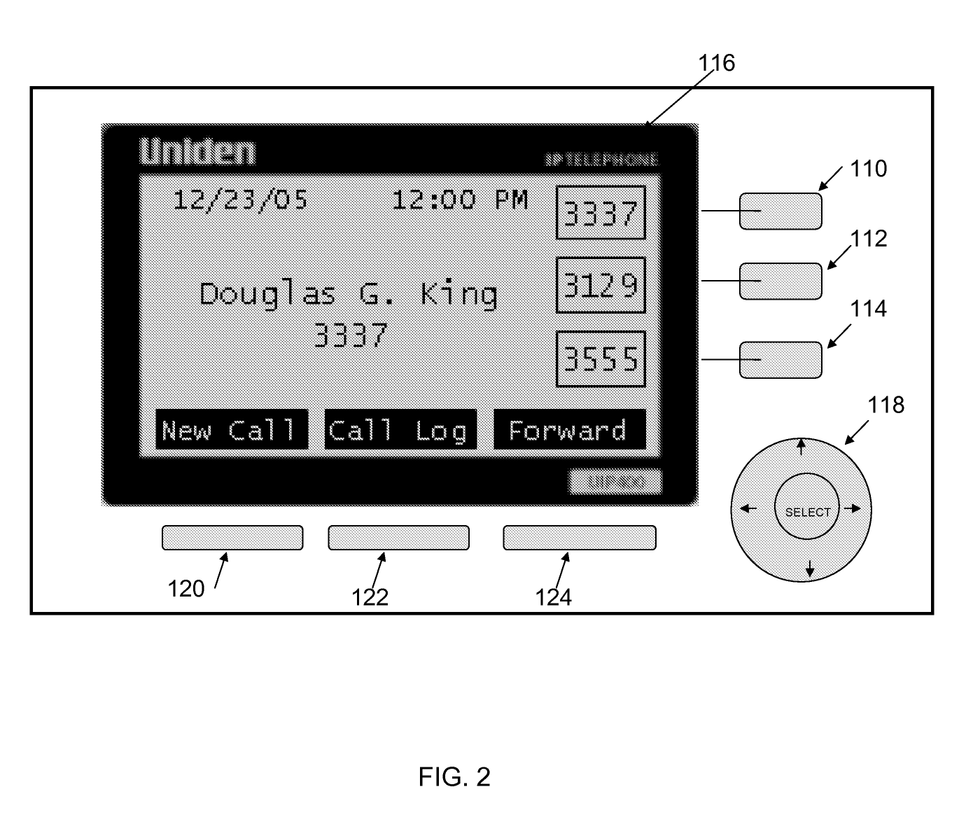

FIG. 2 is an enlarged view of the screen 116. The screen 116 displays the current date and time, the telephone lines (in this example, 3337, 3129, and 3555), the current actions available for the active call (in this example, New Call, Call Log, and Forward) associated with the function keys 120, 122, and 124, and a general text display. The general text display in this example includes the name of the person assigned to active call indicating that 3337 is active and assigned to Douglas G. King.

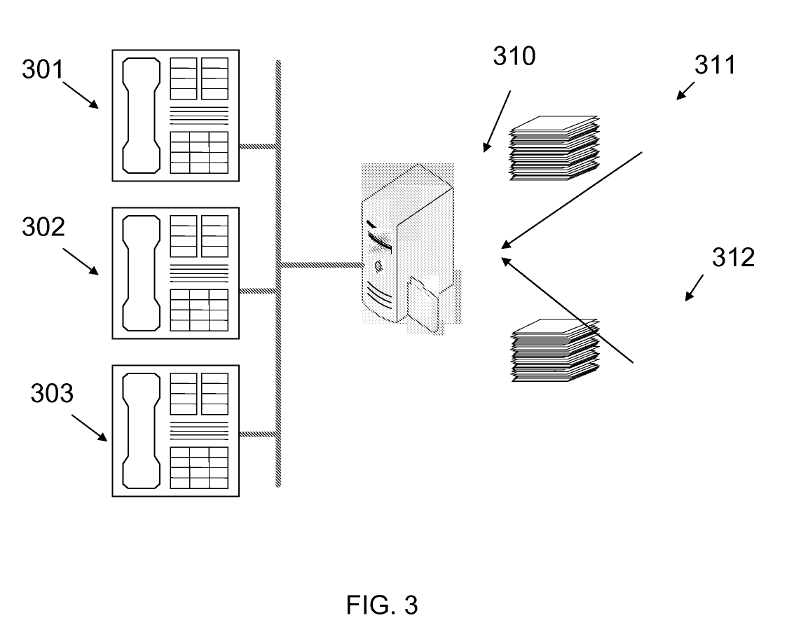

FIG. 3 shows a diagram for remote management of IP phone menuing according to an embodiment of the present invention. In FIG. 3, a plurality of VoIP phones 301-303 can communication with a configuration server 310 across a network (e.g., an IP network), which can include wired and/or wireless connections.

The configuration server 310 includes a set of databases and/or files for remotely managing and provisioning IP phone services. The configuration server 310 contains one or more phone-configuration files 311 and one or more custom phone menu files 312. In this embodiment, the phone-configuration files 311 are files for remotely setting up default configuration settings for each of the VoIP phones 301-303.

The custom phone menu files 312 include information regarding configuration settings for the phones 301-303, including information that can be interpreted by the phones 301-303 for setting up respective customized menus. According to one embodiment of the present invention, an administrator of the network can manage the menus for each phone 301-303 by sending the appropriate custom phone menu file 312 to each of the phones 301-303 from the configuration server 310. In another embodiment, the administrator of the network, at the time of provisioning, can manage each VoIP phone menuing by sending both the phone-configuration file 311 to each of the IP phones (301, 302, and 303) via the configuration server 310 and a specific custom phone menu file 312 to one or a plurality of designated IP phones (301, 302, and 303) via the configuration server 310. In this setting, the administrator of the network is capable of changing the functions and options of each of the IP phones (301, 302, and 303) coupled to the configuration server 310.

Some examples of the kind of custom menuing that can be added or removed include: access to configuration data, status, test data, etc. Other kinds of menuing can be added or removed depending on the privileges and/or needs of the individual users.

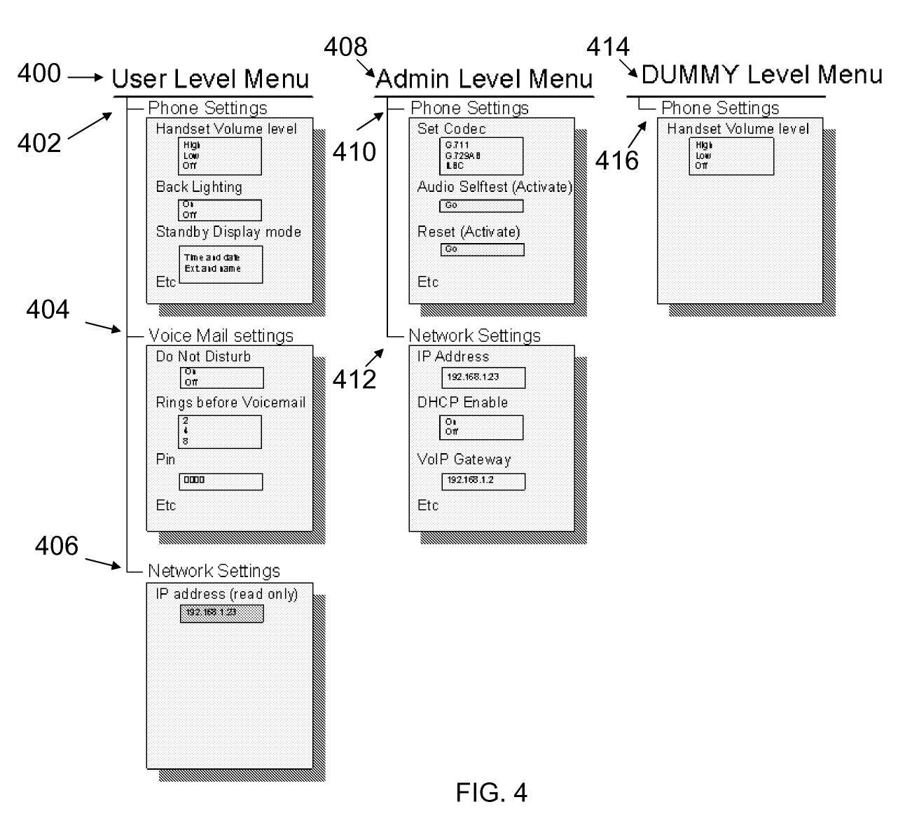

FIG. 4 illustrates some example menu hierarchies. One possible menu hierarchy is the User Level Menu 400. User Level Menu 400 allows a user to change a few phone settings 402. For example, the handset volume level can be set to high, low or off. In addition, the Back lighting can be changed to on or off. Moreover, the Standby display mode can be changed to time and date or extension and name.

A few Voice Mail settings 404 can also be changed through this menu hierarchy 400. For example, Do Not Disturb can be turned on or off. Additionally, the number of rings before a call goes to Voice Mail can be changed. Further, a Personal Identification Number can be changed.

The last example shown is Network settings 406. This function allows the user to see the IP address assigned to this phone.

Another example menu hierarchy shown in this figure is an Admin Level Menu 408. The Admin menu 408 also has a phone settings function 410. This example of phone settings 410 allows an Admin to set a codec, to perform an audio selftest, and to reset the phone. The Admin menu 408 also has network settings feature 412. The network settings 412 allow an Admin to display IP address, the enable DHCP, and also to configure a VoIP gateway address.

A Dummy Level menu 414 is also shown. This Dummy menu 414 has phone settings feature 416 with just the ability to change the handset volume.

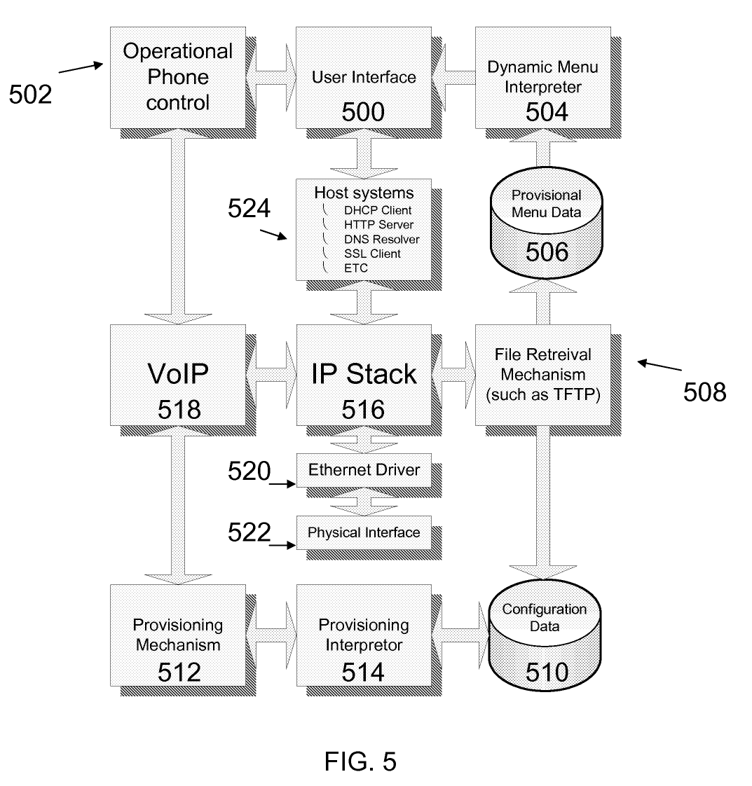

FIG. 5 shows a block diagram of an embodiment of the phone 100. The phone 100 includes a user interface 500, which can include such things as the screen 116, line keys 110, 112, and 114, navigation toggle key 118, function keys 120, 122, and 124, feature keys 128 and 132, and number pad 130. The phone 100 also includes operational phone control 502, which can include such things as a hook switch (not shown) for taking the telephone on and off hook, speaker phone keys, flash keys, and/or headset keys. The phone 100 includes one or more host systems 524, which can include one or more of a DHCP client, an HTTP server, a DNS resolver, and an SSL client. The phone 100 includes an IP stack 516, an Ethernet driver 520, and a physical interface 522, which are collectively operable for allowing the phone 100 to communicate with remote network devices via a packet-switched network.

Other phone systems that communicate via the IP stack 516 with remote entities include the file retrieval mechanism 508 and the VoIP mechanism 518. The file retrieval mechanism 508 retrieves (e.g., from configuration server 310) the provisional menu data 506 (e.g., in the form of a custom phone menu file 312) and the configuration data 510 (e.g., in the form of a phone-configuration file 311) In the present embodiment, the file retrieval mechanism 508 uses Trivial File Transfer Protocol (TFTP) for retrieving the data 506 and 510 from a remote server; however, other protocols can be used. A dynamic menu interpreter 504 detects the presence of new or modified provisional menu data 506 and generates menus for the user interface 500 according to the contents of the provisional menu data 506. A provisioning interpreter 514 detects the configuration data 510 and passes the data 510 to a provisioning mechanism 512, which in turn configures the VoIP mechanism 518 according to the contents of the configuration data 510.

The previous description of the disclosed embodiments is provided to enable those skilled in the art to make or use the present invention. Various modifications to these embodiments will be readily apparent to those skilled in the art and generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of remotely managing phone menus in a phone system, the phone system comprising one or more intelligent phones, the method comprising:
providing a configuration server, wherein the configuration server includes custom phone menu options and default phone menu options;
creating a custom phone menu that includes one or more of the custom phone menu options for at least one of the one or more intelligent phones;
coupling the at least one of the one or more intelligent phones to the configuration server; and
sending the custom phone menu to the at least one of the one or more intelligent phones via the configuration server.

2. The method according to claim 1, further including sending a phone configuration file comprising default menu options to the at least one of the one or more intelligent phones.

3. The method according to claim 1, wherein the custom phone menu is a specifically designed for the at least one of the one or more intelligent phones.

4. The method according to claim 1, wherein the one or more intelligent phones comprises a group of intelligent phones, wherein custom phone menu is a specifically designed for the group of intelligent phones.

5. The method according to claim 1, wherein the configuration server further includes at least one computer including a database, software, and hardware.

6. The method according to claim 1, wherein the custom phone menu includes a menu option for allowing a user access to a configuration file for the custom phone menu.

7. The method according to claim 1, wherein the one or more intelligent phones are intelligent VOIP phones.

8. A system for remote management of intelligent phone menuing, the system comprising:
a plurality of intelligent phones; and
a configuration server in communication with the plurality of intelligent phones,
wherein the configuration server includes custom phone menu options and default phone menu options, and
wherein the configuration server allows a custom phone menu to be arranged that includes one or more of the custom phone menu options, and allows the custom phone menu to be sent to at least one of the plurality of intelligent phones.

9. The system according to claim 8, wherein the configuration server allows for sending a phone configuration file to at least one of the plurality of intelligent phones, the phone configuration file including the default menu options.

10. The system according to claim 8, wherein the custom phone menu is specifically designed for the at least one of the plurality of intelligent phones.

11. The system according to claim 8, wherein the custom phone menu is specifically designed for a group of the plurality of intelligent phones.

12. The system according to claim 8, wherein the configuration server further includes at least one computer including a database, software, and hardware.

13. The system according to claim 8, wherein the custom phone menu includes a menu option for allowing a user access to a configuration file of the custom phone menu.

14. The system according to claim 8, wherein the plurality of intelligent phones are intelligent VOIP phones.

15. A method of remotely customizing a menu of an intelligent phone, the method comprising:
receiving, at a configuration server, user selection of one or more custom phone menu options;
creating, at the configuration server, a custom phone menu file based on the user selection;
receiving, at the configuration server, a user input instructing that the custom phone menu file be sent to the intelligent phone;
sending the custom phone menu file from the configuration server to the intelligent phone in response to the user input;
receiving the custom phone menu file at the intelligent phone; and
creating, at the intelligent phone, a custom phone menu based on the thus received custom phone menu file.

16. The method of claim 15, wherein the sending of the custom phone menu file includes sending the file from the configuration server to the intelligent phone across a computer network.

17. The method of claim 16, wherein the sending of the custom phone menu file includes sending the file from the configuration server to the intelligent phone across the computer network using a Trivial File Transfer Protocol.

18. The method of claim 17, further comprising sending a phone configuration file from the configuration server to the intelligent phone.

19. The method of claim 18, wherein the intelligent phone is a VOIP phone, and wherein the phone configuration file includes default settings for configuring the phone to operate on a network connected to other VOIP phones.

20. The method of claim 19, wherein the creating, at the intelligent phone, of the custom phone menu includes detecting the received custom menu file and, in response to the detecting, generating one or more menus that can be viewed on a user interface of the phone based on the contents of the custom menu file.
